(19) United States
(12) Patent Application Publication
(10) Pub. No.: US 2009/0050528 A1
(43) Pub. Date: Feb. 26, 2009

(54) Low NOx CO Oxidation Promoters

(75) Inventors: Darrell Ray Rainer, Houston, TX (US); Julie Ann Francis, Houston, TX (US); Jorge Alberto Gonzalez, Houston, TX (US); Lin Luo, Lake Jackson, TX (US)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., AMERSFOORT (NL)

(21) Appl. No.: 12/135,461

(22) Filed: Jun. 9, 2008

Related U.S. Application Data
(60) Provisional application No. 60/942,772, filed on Jun. 8, 2007.

(51) Int. Cl. C10G 11/00; B02C 23/00; B01J 29/04; B01J 21/16

(52) U.S. Cl. 208/120.05; 208/120.15; 208/120.3; 208/120.35; 241/3; 502/61; 502/73; 502/74; 502/84; 502/63

(57) ABSTRACT

Particulate compositions for promoting CO oxidation in FCC processes are provided, the compositions comprising an anionic clay support having at least one dopant, wherein at least one compound comprising iridium, rhodium, palladium, copper, or silver is deposited on the anionic clay support, and the composition is substantially free of platinum.

A major industrial problem involves the development of efficient methods for reducing the concentration of air pollutants, such as carbon monoxide, sulfur oxides and nitrogen oxides in waste gas streams which result from the processing and combustion of sulfur, carbon and nitrogen containing fuels. The discharge of these waste gas streams into the atmosphere is environmentally undesirable at the sulfur oxide, carbon monoxide and nitrogen oxide concentrations that are frequently encountered in conventional operations. The regeneration of cracking catalyst, which has been deactivated by coke deposits in the catalytic cracking of sulfur and nitrogen containing hydrocarbon feedstocks, is a typical example of a process, which can result in a waste gas stream containing relatively high levels of carbon monoxide, sulfur and nitrogen oxides.

Catalytic cracking of heavy petroleum fractions is one of the major refining operations employed in the conversion of crude petroleum oils to useful products such as the fuels utilized by internal combustion engines. In fluidized catalytic cracking (FCC) processes, high molecular weight hydrocarbon liquids and vapors are contacted with hot, finely-divided, solid catalyst particles, either in a fluidized bed reactor or in an elongated transfer line reactor, and maintained at an elevated temperature in a fluidized or dispersed state for a period of time sufficient to effect the desired degree of cracking to lower molecular weight hydrocarbons of the kind typically present in motor gasoline and distillate fuels.

In the catalytic cracking of hydrocarbons, some nonvolatile carbonaceous material or coke is deposited on the catalyst particles. Coke comprises highly condensed aromatic hydrocarbons and generally contains from about 4 to about 10 weight percent hydrogen. When the hydrocarbon feedstock contains organic sulfur and nitrogen compounds, the coke also contains sulfur and nitrogen. As coke accumulates on the cracking catalyst, the activity of the catalyst for cracking and the selectivity of the catalyst for producing gasoline blending stocks diminishes. Catalyst which has become substantially deactivated through the deposit of coke is continuously withdrawn from the reaction zone. This deactivated catalyst is conveyed to a stripping zone where volatile deposits are removed with an inert gas at elevated temperatures. The catalyst particles are then reactivated to essentially their original capabilities by substantial removal of the coke deposits in a suitable regeneration process. Regenerated catalyst is then continuously returned to the reaction zone to repeat the cycle.

Catalyst regeneration is accomplished by burning the coke deposits from the catalyst surfaces with an oxygen containing gas such as air. The combustion of these coke deposits can be regarded, in a simplified manner, as the oxidation of carbon and the products are carbon monoxide and carbon dioxide.

High residual concentrations of carbon monoxide in flue gases from regenerators have been a problem since the inception of catalytic cracking processes. The evolution of FCC has resulted in the use of increasingly high temperatures in FCC regenerators in order to achieve the required low carbon levels in the regenerated catalysts. Typically, present day regenerators now operate at temperatures in the range of about 1100° F. to about 1400° F. when no promoter is used and result in flue gases having a CO₂/CO ratio in the range of 36 or higher, in a full burn unit to 0.5. The oxidation of carbon monoxide is highly exothermic and can result in so-called “carbon monoxide afterburning” which can take place in the dilute catalyst phase, in the cyclones or in the flue gas lines. Afterburning has caused significant damage to plant equipment. On the other hand, unburned carbon monoxide in atmosphere-vented flue gases represents a loss of fuel value and is ecologically undesirable.

Restrictions on the amount of carbon monoxide, which can be exhausted into the atmosphere and the process advantages resulting from more complete oxidation of carbon monoxide, have stimulated several approaches to the provision of means for achieving complete combustion of carbon monoxide in the regenerator.

Among the procedures suggested for use in obtaining complete carbon monoxide combustion in an FCC regeneration have been: (1) increasing the amount of oxygen introduced into the regenerator relative to standard regeneration; and either (2) increasing the average operating temperature in the regenerator or (3) including various carbon monoxide oxidation promoters in the cracking catalyst to promote carbon monoxide burning. Various solutions have also been suggested for the problem of afterburning of carbon monoxide, such as addition of extraneous combustibles or use of water or heat-accepting solids to absorb the heat of combustion of carbon monoxide.

Specific examples of treatments applied to regeneration operated in the complete combustion mode include the addition of a CO combustion promoter metal to the catalyst or to the regenerator. For example, U.S. Pat. No. 2,647,860 proposed adding 0.1 to 1 weight percent chromic oxide to a cracking catalyst to promote combustion of CO. U.S. Pat. No. 3,808,121 taught using relatively large-sized particles containing CO combustion-promoting metal into a regenerator. The small-sized catalyst is cycled between the cracking reactor and the catalyst regenerator while the combustion-promoting particles remain in the regenerator. Also, U.S. Pat. Nos. 4,072,600 and 4,093,535 teach the use of Pt, Pd, Ir, Rh, Os, Ru, and Re in cracking catalysts in concentrations of 0.01 to 50 ppm, based on total catalyst inventory to promote CO combustion in a complete burn unit.

The use of precious metals to catalyze oxidation of carbon monoxide in the regenerators of FCC units has gained broad commercial acceptance. Some of the history of this development is set forth in U.S. Pat. No. 4,171,286 and U.S. Pat. No. 4,222,856. In the earlier stages of the development, the precious metal was deposited on the particles of cracking catalyst. Present practice is generally to supply a promoter in the form of solid fluidizable particles containing a precious metal, such particles being physically separate from the particles of cracking catalyst. The precious metal or compound thereof, is supported on particles of suitable carrier material and the promoter particles are usually introduced into the regenerator separately from the particles of cracking catalyst. The particles of promoter are not removed from the system as fines and are cocirculated with cracking catalyst particles during the cracking/stripping/regeneration cycles. Judgment of the CO combustion efficiency of a promoter is done by the ability to control the difference in temperature, delta T, between the (hotter) dilute phase, cyclones or flue gas line, and the dense phase. Most FCC units now use a Pt CO combustion promoter. While the use of combustion promoters such as platinum reduce CO emissions, such reduction in CO emissions is usually accompanied by an increase in nitrogen oxides (NOx) in the regenerator flue gas.

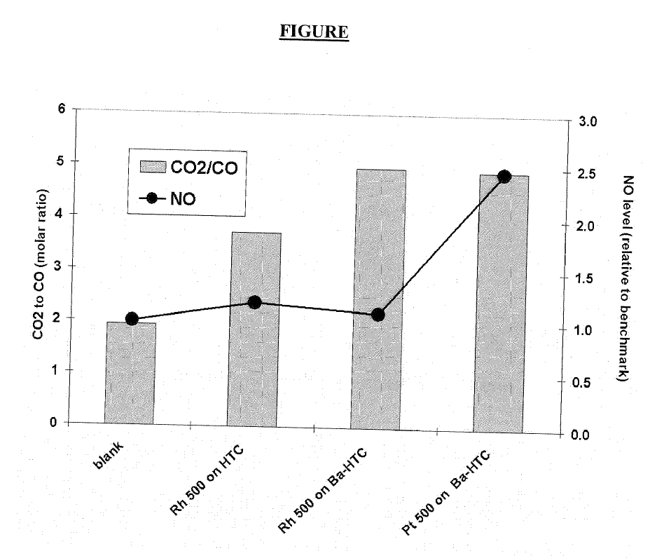

Promoter products used on a commercial basis in FCC units include calcined spray dried porous microspheres of kaolin clay impregnated with a small amount (e.g., 100 to 1500 ppm) of platinum. Reference is made to U.S. Pat. No. 4,171,286 (supra). Most commercially used promoters are obtained by impregnating a source of platinum on microspheres of high purity porous alumina, typically gamma alumina. The selection of platinum as the precious metal in various commercial products appears to reflect a preference for this metal that is consistent with prior art disclosures that platinum is the most effective group VIII metal for carbon monoxide oxidation promotion in FCC regenerators, See, for example, FIG. 3 in U.S. Pat. No. 4,107,032 and the same figure in U.S. Pat. No. 4,350,614. The FIGURE illustrates the effect of increasing the concentration of various species of precious metal promoters from 0.5 to 10 ppm on CO₂/CO ratio.

U.S. Pat. No. 4,608,357 teaches that palladium is unusually effective in promoting the oxidation of carbon monoxide to carbon dioxide under conditions such as those that prevail in the regenerators of FCC units when the palladium is supported on particles of a specific form of silica-alumina, namely leached mullite. The palladium may be the sole catalytically active metal component of the promoter or it may be mixed with other metals such as platinum.

U.S. Pat. Nos. 5,164,072 and 5,110,780, relate to an FCC CO promoter having Pt on La-stabilized alumina, preferably about 4-8 weight percent La₂O₃. It is disclosed that ceria “must be excluded.” At col. 3, it is disclosed that “In the presence of an adequate amount of La₂O₃, say about 6-8 percent, 2 percent Ce is useless. It is actually harmful if the La₂O₃ is less.” In an illustrative example '072 and '780 demonstrates an adverse effect of 8% Ce on CO promotion of platinum supported on a gamma alumina and a positive effect of La.

When sulfur and nitrogen containing feedstocks are utilized in catalytic cracking process, the coke deposited on the catalyst contains sulfur and nitrogen. During regeneration of coked deactivated catalyst, the coke is burned from the catalyst surface that then results in the conversion of a portion of the sulfur and nitrogen to sulfur oxides and nitrogen oxides, respectively.

Unfortunately, the more active combustion promoters such as platinum and palladium also serve to promote the formation of nitrogen oxides in the regeneration zone. It has been reported that the use of prior art CO promoters can cause a dramatic increase (e.g. >300%) in NOₓ. It is difficult in a catalyst regenerator to completely burn coke and CO without increasing the NOₓ content of the regenerator flue gas. Since the discharge of nitrogen oxides into the atmosphere is environmentally undesirable, the use of these promoters has the effect of substituting one undesirable emission for another. Many jurisdictions restrict the amount of NOₓ that can be in a flue gas stream discharged to the atmosphere. In response to environmental concerns, much effort has been spent on finding ways to reduce NOₓ emissions.

Various approaches have been used to either reduce the formation of NOₓ or treat them after they are formed. Most typically, additives have been used either as an integral part of the FCC catalyst particles or as separate particles in admixture with the FCC catalyst.

Various additives have been developed that will carry out CO promotion while controlling NOₓ emissions.

U.S. Pat. Nos. 4,350,614, 4,072,600 and 4,088,568 mention rare earth addition to Pt based CO promoters. An example is 4% REO that shows some advantage. There is no teaching of any effect of REO on decreasing NOₓ emissions from the FCCU.

U.S. Pat. No. 4,199,435 teaches a combustion promoter selected from the Pt, Pd, Ir, Os, Ru, Rh, Re and copper on an inorganic support.

U.S. Pat. No. 4,290,878 teaches a Pt—Ir and Pt—Rh bimetallic promoter that reduces NOₓ compared to conventional Pt promoter.

U.S. Pat. No. 4,300,997 patent teaches the use of a Pd—Ru promoter for oxidation of CO that does not cause excessive NOₓ formation.

U.S. Pat. No. 4,544,645 describes a bimetallic of Pd with every other Group VIII metal but Ru.

U.S. Pat. Nos. 6,165,933 and 6,358,881 to W. R. Grace describe compositions comprising a component containing (i) an acidic oxide support, (ii) an alkali metal and/or alkaline earth metal or mixtures thereof, (iii) a transition metal oxide having oxygen storage capability, and (iv) palladium; to promote CO combustion in FCC processes while minimizing the formation of NOₓ.

U.S. Pat. No. 6,117,813 teaches a CO promoter consisting of a Group VIII transition metal oxide, Group IIIB transition metal oxide and Group IIA metal oxide.

There is still a need, however, for improved CO oxidation promoters having NOₓ emission control in FCC processes.

The present invention provides novel compositions suitable for use in FCC processes that are capable of providing improved CO oxidation promotion activity along with NOₓ emission control.

In one aspect, the invention provides particulate compositions for promoting CO oxidation in FCC processes, the compositions comprising an anionic clay support having at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba²⁺, Zn²⁺, Mn²⁺, Co²⁺, Mo²⁺, Ni²⁺, Fe²⁺, Sr²⁺, Cu²⁺, wherein at least one compound comprising iridium, rhodium, palladium, copper, and silver is deposited on the anionic clay support, and the composition is substantially free of platinum.

In another aspect, the invention encompasses FCC processes using the CO oxidation promotion particulate compositions of this invention either as an integral part of the FCC catalyst particles or as separate particles admixed with the FCC catalyst. The composition provides lower NOₓ emissions than prior art CO oxidation promoters.

These and other aspects of the invention are described in further detail below.

### BRIEF DESCRIPTION OF THE FIGURE

The FIGURE represents a graphical representation of the data generated in the Example.

### DETAILED DESCRIPTION OF THE INVENTION

In one aspect, the invention encompasses the discovery that certain classes of compositions are very effective for both the oxidation of CO and reduction of NOₓ gas emissions in FCC processes. The CO oxidation compositions of the inventions are characterized in that they comprise an anionic clay support having at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba²⁺, Zn²⁺, Mn²⁺, Co²⁺, Mo²⁺, Ni²⁺, Fe²⁺, Sr²⁺, Cu²⁺, wherein at least one compound comprising iridium, rhodium, palladium, copper, and silver is deposited on the anionic clay support, and the composition is substantially free of platinum.

In the particulate composition according to the invention, the at least one compound comprising iridium, rhodium, palladium, copper, and silver is deposited on the anionic clay. A suitable method to prepare this particulate composition is impregnation of an existing anionic clay with a solution containing a salt of the at least one compound comprising iridium, rhodium, palladium, copper, and silver. This solution is preferably aqueous, but may also be organic in nature.

Suitable salts include chlorides, nitrates, and other complexes that are soluble in the liquid used for making the impregnation solution.

Any conventional technique can be used for impregnation. Examples are wet impregnation or incipient wetness impregnation.

Anionic clays have a crystal structure consisting of positively charged layers of specific combinations of divalent and trivalent metal hydroxides between which there are anions and water molecules. Hydrotalcite is an example of a naturally occurring anionic clay wherein Mg is the divalent metal, Al is the trivalent metal, and carbonate is the predominant anion present. Meixnerite is an anionic clay wherein Mg is the divalent metal, Al is the trivalent metal, and hydroxyl is the predominant anion present.

Anionic clays are further subdivided according to the identity of the atoms that make up their crystalline structures. For example, anionic clays in the pyroaurite-sjogrenite-hydrotalcite group are based upon brucite-like layers (wherein magnesium cations are octahedrally surrounded by hydroxyl groups) which alternate with interstitial layers of water molecules and/or various anions (e.g., carbonate ions). When some of the magnesium in a brucite-like layer is isomorphously replaced by a higher charged cation, e.g., Al³⁺, then the resulting Mg^{2+—Al}³³⁰ —OH layer gains in positive charge. Hence, an appropriate number of interstitial anions, such as those noted above, are needed to render the overall compound electrically neutral.

Natural minerals that exhibit such crystalline structures include, but by no means are limited to, pyroaurite, sjogrenite, hydrotalcite, stichtite, reevesite, eardleyite, mannaseite, barbertonite and hydrocalumite.

Anionic clays are also often referred to as “mixed metal hydroxides” or “layered double hydroxides.” This expression derives from the fact that, as noted above, positively charged metal hydroxide sheets of anionic clays may contain two metal cations in different oxidation states (e.g., Mg²⁺ and Al³⁺). Moreover, because the XRD patterns for so many anionic clays are similar to that of hydrotalcite, Mg₆Al₂(OH)₁₆(CO₃).4H₂O, anionic clays also are also commonly referred to as “hydrotalcite-like compounds.”

For the purposes of this specification, (unless otherwise stated) use of the term “hydrotalcite-like” compound(s) and “anionic clays” shall be considered interchangeable with the understanding that these terms should be taken to include anionic clays, hydrotalcite itself as well as any member of that class of materials generally known as “hydrotalcite-like compounds.”

The preparation of anionic clays has been described in many prior art publications. Two major reviews of anionic clay chemistry were published in which the synthesis methods available for anionic clay synthesis have been summarized: F. Cavani et al ““Hydrotalcite-type anionic clays: Preparation, Properties and Applications,” Catalysis Today”, 11 (1991) Elsevier Science Publishers B. V. Amsterdam; and J P Besse and others “Anionic clays: trends in pillary chemistry, its synthesis and microporous solids” (1992), 2, 108, editors: M. I. Occelli, H. E. Robson, Van Nostrand Reinhold, N.Y.

In these reviews the authors state that a characteristic of Mg—Al anionic clays is that mild calcination at 500° C. results in the formation of a disordered MgO-like product. The disordered MgO-like product is distinguishable from spinel (which results upon severe calcination) and from anionic clays. In this specification we refer to disordered MgO-like materials as Mg—Al solid solutions. Furthermore, these Mg—Al solid solutions contain a well-known memory effect whereby the exposure to water of such calcined materials results in the reformation of the anionic clay structure.

Two types of anionic clay preparation are described in these reviews. The most conventional method is co-precipitation (in Besse this method is called the salt-base method) of a soluble divalent metal salt and a soluble trivalent metal salt, optionally followed by hydrothermal treatment or aging to increase the crystallite size. The second method is the salt-oxide method in which a divalent metal oxide is reacted at atmospheric pressure with a soluble trivalent metal salt, followed by aging under atmospheric pressure. This method has only been described for the use of ZnO and CuO in combination with soluble trivalent metal salts.

For work on anionic clays, reference is further made to the following articles: Chemistry Letters (Japan), 843 (1973) Clays and Clay Minerals, 23, 369 (1975) Clays and Clay Minerals, 28, 50 (1980) Clays and Clay Minerals, 34, 507 (1996) Materials Chemistry and Physics, 14, 569 (1986).

The particulate compositions of the present invention are made by the following process. Generally, the process comprises the steps of: a) milling a physical mixture of a divalent metal compound and a trivalent metal compound, b) calcining the physical mixture at a temperature in the range of about 200 to about 800° C., and c) rehydrating the calcined mixture in aqueous suspension to form an anionic clay, wherein at least one compound comprising iridium, rhodium, palladium, copper, and silver is present in the physical mixture and/or the aqueous suspension of step c).

In this specification, the term “milling” is defined as any method that results in reduction of particle size. Such a particle size reduction can at the same time result in the formation of reactive surfaces and/or heating of the particles. Instruments that can be used for milling include ball mills, high-shear mixers, colloid mixers, and electrical transducers that can introduce ultrasound waves into a slurry. Low-shear mixing, i.e. stirring that is performed essentially to keep the ingredients in suspension, is not regarded as “milling”.

The physical mixture can be milled as dry powder or in suspension. It will be clear that, when the physical mixture is in suspension, at least one of the metal compounds present in the mixture (the divalent metal compound, the trivalent metal compound, or both) must be water-insoluble.

Suitable divalent metals include magnesium, zinc, nickel, copper, iron, cobalt, manganese, calcium, barium, strontium, and combinations thereof. Preferred divalent metals include magnesium, manganese and iron, or combinations thereof. Suitable zinc, nickel, copper, iron, cobalt, manganese, calcium, strontium, and barium compounds are their respective water-insoluble oxides, hydroxides, carbonates, hydroxycarbonates, bicarbonates, and clays and, generally water-soluble salts such as acetates, hydroxyacetates, nitrates, and chlorides. Suitable water-insoluble magnesium compounds include magnesium oxides or hydroxides such as MgO, Mg(OH)₂, magnesium carbonate, magnesium hydroxy carbonate, magnesium bicarbonate, hydromagnesite and magnesium-containing clays such as dolomite, saponite, and sepiolite. Suitable water-soluble magnesium compounds are magnesium acetate, magnesium formate, magnesium (hydroxy) acetate, magnesium nitrate, and magnesium chloride.

Preferred divalent metal compounds are oxides, hydroxides, carbonates, hydroxycarbonates, bicarbonates, and (hydroxy)acetates, as these materials are relatively inexpensive. Moreover, these materials do not leave undesirable anions in the anionic clay which either have to be washed out or will be emitted as environmentally harmful gases upon heating.

Suitable trivalent metals include aluminium, gallium, iron, chromium, vanadium, cobalt, manganese, nickel, indium, cerium, niobium, lanthanum, and combinations thereof. The preferred trivalent metal is aluminum. Suitable gallium, iron, chromium, vanadium, cobalt, nickel, and manganese compounds are their respective water-insoluble oxides, hydroxides, carbonates, hydroxycarbonates, bicarbonates, alkoxides, and clays and generally water-soluble salts like acetates, hydroxyacetates, nitrates, and chlorides. Suitable water-insoluble aluminium compounds include aluminium oxides and hydroxides such as transition alumina, aluminium trihydrate (bauxite ore concentrate, gibbsite, bayerite) and its thermally treated forms (including flash-calcined aluminium trihydrate), sols, amorphous alumina, and (pseudo)boehmite, aluminium-containing clays such as kaolin, sepiolite, bentonite, and modified clays such as metakaolin. Suitable water-soluble aluminium salts are aluminium nitrate, aluminium chloride, aluminium chlorohydrate, and sodium aluminate.

Preferred trivalent metal compounds are oxides, hydroxides, carbonates, bicarbonates, hydroxycarbonates, and (hydroxy)acetates, as these materials are relatively inexpensive. Moreover, these materials do not leave undesirable anions in the anionic clay which either have to be washed out or will be emitted as environmentally harmful gases upon heating.

The anionic clay support of the present invention is doped with at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba², Zn²⁺, Mn^{2+, Co}²⁺, Mo²⁺, Ni²⁺, Fe²⁺,Sr²⁺, Cu²⁺.

The anionic clay support may be doped by co-precipitating one or more doped metal compounds, which can be prepared in several ways. In general, the metal compound and a dopant are converted to a dopant-containing metal compound in a homogeneously dispersed state.

The dopants may be employed as nitrates, sulfates, chlorides, formates, acetates, oxalates, alkoxides, carbonates, and tungstates. The use of compounds with heat-decomposable anions is preferred, because the resulting doped metal compounds can be dried directly, without intermittent washing, as anions undesirable for catalytic purposes are not present.

As stated above, the first step in the process of the invention involves milling of a physical mixture of the divalent and the trivalent metal compound. This physical mixture can be prepared in various ways. The divalent and trivalent metal compound can be mixed as dry powders (either doped or exchanged) or in (aqueous) suspension thereby forming a slurry, a sol, or a gel. In the latter case, the divalent and trivalent metal compound are added to the suspension as powders, sols, or gels and the preparation and milling of the mixture is followed by drying.

If the physical mixture is prepared in aqueous suspension, dispersing agents can be added to the suspension. Suitable dispersing agents include surfactants, phosphates, sugars, starches, polymers, gelling agents, swellable clays, etc. Acids or bases may also be added to the suspension.

The molar ratio of divalent to trivalent metal in the physical mixture preferably ranges from about 0.01 to about 10, more preferably about 0.1 to about 5, and most preferably about 1 to about 3. The physical mixture is milled, either as dry powder or in suspension. In addition to milling of the physical mixture, the divalent metal compound and the trivalent metal compound may be milled individually before forming the physical mixture.

When the physical mixture is milled in suspension, the mixture is wet milled for about 1 to about 30 minutes at room temperature, for instance in a ball mill, a bead mill, a sand mill, a colloid mill, a high shear mixer, a kneader, or by using ultrasound. After wet milling and before calcination, the physical mixture must be dried, for example spray-drying may be employed.

In addition to drying the physical mixture, in order to optimize binding characteristics, the physical mixture may be aged from about 15 minutes to about 6 hours at a temperature in the range of about 20 to about 90° C., more preferably from about 30 to about 60° C.

The preferred average size of the particles obtained after milling is about 0.1 to about 10 microns, more preferably about 0.5 to about 5 microns, most preferably about 1 to about 3 microns. The temperature during milling may be ambient or higher. Higher temperatures may for instance result naturally from the milling process or may be generated by external heating sources. Preferably, the temperature during milling ranges from about 20 to about 90° C., more preferably from about 30 to about 50° C.

The physical mixture is calcined at a temperature in the range of about 200 to about 800° C., more preferably in the range of about 300 to about 700° C., and most preferably in the range from about 350 to about 600° C. Calcination is conducted for about 0.25 to about 25 hours, preferably for about 1 to about 8 hours, and most preferably for about 2 to about 6 hours. All commercial types of calciners can be used, such as fixed bed or rotating calciners.

Calcination can be performed in various atmospheres, e.g, in air, oxygen, inert atmosphere (e.g. N2), steam, or mixtures thereof.

The so-obtained calcined material must contain rehydratable oxide. The amount of rehydratable oxide formed depends on the type of divalent and trivalent metal compound used and the calcination temperature. Preferably, the calcined material contains about 10 to 100% of rehydratable oxide, more preferably about 30 to 100%, even more preferably about 50 to 100%, and most preferably about 70 to 100% of rehydratable oxide. The amount of rehydratable oxide formed in step b) is equivalent to and calculated from the amount of anionic clay obtained in step c). This amount can be determined by mixing various known amounts of pure anionic clay with samples of the rehydrated product of step c). Extrapolation of the relative intensities of anionic clay to non-anionic clay in these mixed samples—as measured with Powder X-Ray Diffraction (PXRD)—can then be used to determine the amount of anionic clay in the rehydrated product. An example of an oxide that is not rehydratable is a spinel-type oxide.

Rehydration of the calcined material is conducted by contacting the calcined mixture with a water or an aqueous solution of anions. This can be done by passing the calcined mixture over a filter bed with sufficient liquid spray, or by suspending the calcined mixture in the liquid. The temperature of the liquid during rehydration is preferably between about 25 and about 350° C., more preferably between about 25 and about 200° C., most preferably between about 50 and about 150° C., the temperature of choice depending on the nature of the divalent and trivalent metal compound used. Rehydration is performed for about 20 minutes to about 24 hours, preferably about 30 minutes to about 8 hours, more preferably about 1 to about 4 hours.

During rehydration, the suspension can be milled by using high-shear mixers, colloid mixers, ball mills, kneaders, ultrasound, etc. Rehydration can be performed batch-wise or continuously, optionally in a continuous multi-step operation according to pre-published United States patent application no. 2003-0003035. For example, the rehydration suspension is prepared in a feed preparation vessel, whereafter the suspension is continuously pumped through two or more conversion vessels. Additives, acids, or bases, if so desired, can be added to the suspension in any of the conversion vessels. Each of the vessels can be adjusted to its own desirable temperature.

During rehydration, anions can be added to the liquid. Examples of suitable anions include inorganic anions like NO₃⁻, NO₂⁻, CO₃²⁻, HCO₃⁻, SO42−, SO₃NH₂, SCN⁻, S₂O₆²⁻, SeO₄⁻, F⁻, Cl⁻, Br⁻, I⁻, ClO₃⁻, ClO₄⁻, BrO₃⁻, and IO₃⁻, silicate, aluminate, and metasilicate, organic anions like acetate, oxalate, formate, long chain carboxylates (e.g. sebacate, caprate and caprylate (CPL)), alkylsufates (e.g. dodecylsulfate (DS) and dodecylbenzenesulfate), stearate, benzoate, phthalocyanine tetrasulfonate, and polymeric anions such as polystyrene sulfonate, polyimides, vinylbenzoates, and vinyldiacrylates, and pH-dependent boron-containing anions, bismuth-containing anions, thallium-containing anions, phosphorus-containing anions, silicon-containing anions, chromium-containing anions, tungsten-containing anions, molybdenum-containing anions, iron-containing anions, niobium-containing anions, tantalum-containing anions, manganese-containing anions, aluminium-containing anions, and gallium-containing anions.

The doped anionic clay to be used in the process according to the present invention is deposited with at least one compound selected from the group consisting of iridium, rhodium, palladium, copper, and silver. The compound is preferably an oxide, hydroxide, carbonate, or hydroxycarbonate of the desired element. The compound may be present in the physical mixture and/or to the aqueous suspension of step c).

If present in the physical mixture, the compound may be added to the physical mixture before or during milling step a), during calcination step b), or between milling step a) and calcination step b). Addition during calcination requires the use of a calciner with sufficient mixing capability that can be effectively used as mixer as well as calciner. The compound can be added to the physical mixture in step a) and the suspension of step c) as a solid powder, in suspension or, preferably, in solution. If added during calcination, it is added in the form of a powder.

The resulting composition can be subjected to additional calcination and optionally additional rehydration steps. If calcination is followed by a subsequent rehydration, an anionic clay is formed analogous to the one formed after the first rehydration step, but with an increased mechanical strength. These second calcinations and rehydration steps may be conducted under conditions which are either the same or different from the first calcination and rehydration steps. Additional compounds may be added during the additional calcination step(s) and/or during the rehydration step(s). These additional compounds can be the same or different from the additive present in the physical mixture and/or the aqueous suspension of step c).

Furthermore, during the additional rehydration step(s), anions can be added. Suitable anions are the ones mentioned above in relation to the first rehydration step. The anions added during the first and the additional rehydration step can be the same or different.

If so desired, the composition prepared according to the process of the present invention can be mixed with conventional catalyst or sorbent ingredients such as silica, alumina, aluminosilicates, zirconia, titania, boria, (modified) clays such as kaolin, acid leached kaolin, dealuminated kaolin, smectites, and bentonite, (modified or doped) aluminium phosphates, zeolites (e.g. zeolite X, Y, REY, USY, RE-USY, or ZSM-5, zeolite beta, silicalites), phosphates (e.g. meta or pyro phosphates), pore regulating agents (e.g. sugars, surfactants, polymers), binders, fillers, and combinations thereof. The composition, optionally mixed with one or more of the above conventional catalyst components, can be shaped to form shaped bodies. Suitable shaping methods include spray-drying, pelletising, extrusion (optionally combined with kneading), beading, or any other conventional shaping method used in the catalyst and absorbent fields or combinations thereof.

The at least one compound selected from the group consisting of iridium, rhodium, palladium, copper, and silver is present on the anionic clay in a preferred amount of 0.001 to 2.0 wt %, more preferably 0.01 to 2.0, even more preferably 0.01 to 1.0 wt %, and most preferably 0.01 to 0.15 wt %, measured as metal and based on the weight of the anionic clay.

A catalyst composition preferably comprises 1.0 to 100 wt %, more preferably 1.0 to 40 wt %, even more preferably 3.0 to 25 wt %, and most preferably 3.0 to 15 wt % of the composition of the present invention.

The catalyst composition according to the invention preferably has a particle size of 20 to about 2000 microns, preferably 20-600 microns, more preferably 20-200 microns, and most preferably 30-100 microns.

Where the additive composition is used as an additive particulate (as opposed to being integrated into the FCC catalyst particles themselves), the amount of additive component in the additive particles is preferably at least 50 wt %, more preferably at least 75 wt. %. Most preferably, the additive particles consist entirely of the additive component. The additive particles are preferably of a size suitable for circulation with the catalyst inventory in an FCC process. The additive particles preferably have an average particle size of about 20-200 μm. The additive particles preferably have attrition characteristics such that they can withstand the severe environment of an FCCU.

As previously mentioned the additive composition of the invention may be integrated into the FCC catalyst particles themselves. In such case, any conventional FCC catalyst particle components may be used in combination with the additive composition of the invention. If integrated into the FCC catalyst particles the additive composition of the invention preferably represents at least about 0.02 wt. % the FCC catalyst particle.

Where the additive component of the invention is integrated into an FCC catalyst particle, preferably the component is first formed and then combined with the other constituents which make up the FCC catalyst particle. Incorporation of the additive composition directly into FCC catalyst particles may be accomplished by any known technique. Examples of suitable techniques for this purpose are disclosed in U.S. Pat. Nos. 3,957,689; 4,499,197; 4,542,188 and 4,458,623, the disclosures of which are incorporated herein by reference.

The compositions of the invention may be used in any conventional FCC process. Typical FCC processes are conducted at reaction temperatures of 450 to 650° C. with catalyst regeneration temperatures of 600 to 850° C. The compositions of the invention may be used in FCC processing of any typical hydrocarbon feedstocks. Preferably, the compositions of the invention are used in FCC processes involving the cracking of hydrocarbon feedstocks which contain above average amounts of nitrogen, especially residual feedstocks or feedstocks having a nitrogen content of at least 0.1 wt. %. The amount of the additive component of the invention used may vary depending on the specific FCC process. Preferably, the amount of additive component used (in the circulating inventory) is about 0.05-15 wt. % based on the weight of the FCC catalyst in the circulating catalyst inventory. The presence of the compositions of the invention during the FCC process catalyst regeneration step effectively promotes the oxidation of CO while minimizing the ultimate level of NOₓ production as well.

### EXAMPLES

The additive samples in this example are all prepared by adding the appropriate metallic precursor (examples: platinum chloride, rhodium nitrate, palladium chloride, etc.) or combination of metallic precursors in a drop-wise, incipient wetness-type metal impregnation using a solution prepared to achieve the desired metal loading on the final sample. After the solution is added quantitatively to the anionic clay support, the resulting sample is dried in an oven at 110° C. for 12 hours, in order to decompose the precursor(s) and remove the excess water, and then removed and allowed to cool to room temperature.

The additives in the following example have been subjected to conditions to simulate exposure in a typical industrial fluid catalytic cracking unit (FCCU) for a prescribed period equal to about 1 day as a deactivation method. Each additive was blended at 1% by weight of the total final quantity into an unregenerated spent catalyst obtained from an industrial FCCU. The entire mixture was then subjected to conditions simulating the coke-burning step in the FCCU regenerator, and the CO, CO₂, and NO integrated gas levels were monitored until all the coke was burned and no additional gases from coke burning were evolved.

In the example presented below, the first sample is a blank (spent catalyst alone with no additive included) tested to establish the baseline for CO, CO₂, and NO for the coke combustion. The gray bars refer to the left-hand axis, which is the integrated molar CO₂ to molar CO ratio measured during the combustion. The black points refer to the right-hand axis, the NO level reported as a fraction relative to the NO level of the spent catalyst alone (so this value is 1.0 for the blank).

The effect of including the 3 example additives is clear in every case; the ratio of CO₂ to CO is increased due to the CO combustion activity of the additive, and the NO level increases, accurately reflecting the typical commercial result.

Comparing the two analogous Rh samples, the HTC support modified with Ba shows superior CO combustion relative to the sample with unmodified HTC, and slightly lower NO level. Another way of comparing them is to look at the ratio of fractional CO decrease (relative to the spent catalyst alone) over the fractional NO level (again relative to the spent catalyst alone) for each sample. The higher this number (which is referred to as the CONO factor), the more effective the additive in terms of promoting CO combustion while minimizing the attendant NO increase. In this case, the unmodified HTC sample exhibits a CONO factor of 0.32, while the sample with Ba incorporated into the support yields 0.45, clearly demonstrating the improved performiance associated with the doped HITC.

Comparing this same sample with the analogous Pt Ba-HTC additive, the CO combustion activity is almost identical, but the NO increase is less than half for the non-Pt sample (CONO factor 0.45 vs. 0.20), establishing the superiority of the non-Pt sample.

1. A particulate composition suitable for promoting the oxidation of CO during catalyst regeneration in a fluid catalytic cracking process, said composition comprising an anionic clay support having at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba²⁺, Zn²⁺, Mn²⁺, Co²⁺, Mo²⁺, Ni²⁺, Fe²⁺, Sr²⁺, Cu²⁺, wherein at least one compound comprising iridium, rhodium, palladium, copper, or silver is deposited on the anionic clay support, and the composition is substantially free of platinum.

2. The composition of claim 1 wherein the anionic clay support is a hydrotalcite-like compound.

3. The composition of claim 2 wherein the anionic clay is hydrotalcite.

4. A process for the preparation of a particulate composition suitable for promoting the oxidation of CO during catalyst regeneration in a fluid catalytic cracking process wherein the particulate composition comprises an anionic clay support having at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba²⁺, Zn²⁺, Mn²⁺, Co²⁺, Mo²⁺, Ni²⁺, Fe²⁺, Sr²⁺, Cu²⁺, at least one compound comprising iridium, rhodium, palladium, copper, or silver is deposited on the anionic clay support, and the composition is substantially free of platinum, the process comprising the steps of:
a) milling a physical mixture of a divalent metal compound and a trivalent metal compound,
b) calcining the milled physical mixture at a temperature in the range of about 200 to about 800° C., and
c) rehydrating the calcined mixture in aqueous suspension to form the anionic clay,
wherein the dopant is present in the physical mixture of step (a) and/or the aqueous suspension of step (c) and the particulate composition is essentially free of platinum.

5. The process of claim 4, wherein the milling is performed in a ball mill, a bead mill, a sand mill, a colloid mill, a kneader, or a high shear mixer, or by using ultrasound.

6. The process of claim 4 wherein the calcination temperature ranges from about 300 to about 700° C.

7. The process of claim 6 wherein the calcination temperature ranges from about 350 to about 600° C.

8. The process of claim 4 further comprising the step of aging the physical mixture of step a).

9. The process of claim 8 wherein the aging ranges from about 15 min to about 6 hours at a temperature ranging from about 20 to about 90° C.

10. The process of claim 4 wherein the divalent metal is magnesium, zinc, nickel, copper, iron, cobalt, manganese, calcium, barium, strontium, and combinations thereof.

11. The process of claim 10 wherein the divalent metal is magnesium, manganese, iron, or combinations thereof.

12. The process of claim 4 wherein the trivalent metal is aluminum, gallium, iron, chromium, vanadium, cobalt, manganese, nickel, indium, cerium, niobium, lanthanum, and combinations thereof.

13. The process of claim 12 wherein the trivalent metal is aluminum.

14. The process of claim 4 further comprising the step of a subsequent calcination of the formed anionic clay.

15. The process of claim 14 further comprising the step of rehydrating subsequently calcined anionic clay.

16. A method of promoting CO oxidation during fluid catalytic cracking of a hydrocarbon feedstock into lower molecular weight components said method comprising contacting a hydrocarbon feedstock with a cracking catalyst suitable for catalyzing the cracking of hydrocarbons at elevated temperature whereby lower molecular weight hydrocarbon components are formed in the presence of a particulate CO oxidation promotion, wherein said particulate composition comprises an anionic clay support having at least one dopant selected from the group consisting of Ga³⁺, In³⁺, Bi³⁺, Fe³⁺, Cr³⁺, Co³⁺, Sc³⁺, La³⁺, Ce³⁺, Ca²⁺, Ba²⁺, Zn²⁺, Mn²⁺, Co²⁺, Mo²⁺, Ni²⁺, Fe²⁺, Sr²⁺, Cu²⁺, at least one compound comprising iridium, rhodium, palladium, copper, or silver is deposited on the anionic clay support, and the composition is substantially free of platinum, said CO reduction composition being present in an amount sufficient to reduce said CO emissions.

17. The method of claim 16 wherein said cracking catalyst is fluidized during contact with a hydrocarbon feedstock.

18. The method of claim 17 further comprising recovering used cracking catalyst from said contacting step and treating said used catalyst under conditions to regenerate said catalyst.

19. The method of claim 17 wherein said hydrocarbon feedstock contains at least 0.1 wt % nitrogen.
